(19) United States
(12) Patent Application Publication
(10) Pub. No.: US 2008/0171143 A1
(43) Pub. Date: Jul. 17, 2008

(54) Process For Preparation Of Optical Compensatory Sheet

(75) Inventors: Naoyuki Nishikawa, Kanagawa (JP); Masahiro Toida, Kanagawa (JP); Shin-ichi Morishima, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/792,706

(22) PCT Filed: Dec. 13, 2005
(86) PCT No.: PCT/JP2005/023415

§ 371 Date: Jun. 11, 2007

(30) Foreign Application Priority Data
Dec. 13, 2004 (JP) 2004-360036

(51) Int. Cl. B05D 5/06

(52) U.S. Cl. 427/162

(57) ABSTRACT

A process for preparation of an optical compensatory sheet is disclosed. The process comprises the steps in order of: coating a support with a photosensitive compound; exposing the photosensitive compound to beams of linearly polarized light emitted from a semiconductor laser to form an orientation layer; coating the orientation layer with a liquid crystal composition containing polymerizable liquid crystal molecules; aligning the liquid crystal molecules to form an optically anisotropic layer; and then polymerizing the liquid crystal molecules to fix alignment.

### TECHNICAL FIELD

The present invention relates to a process for preparation of an optical compensatory sheet comprising a polymerization product of liquid crystal molecules. In the process, photosensitive compounds are exposed to beams of light emitted from a semiconductor laser to form an orientation layer, which aligns the liquid crystal according to a photo-orientation method.

### BACKGROUND ART

An optical compensatory sheet is used in various liquid crystal displays to prevent a displayed image from unfavorable coloring or to enlarge a viewing angle. A stretched birefringent film has conventionally been used as the optical compensatory sheet. Recently, an optical compensatory sheet comprising a transparent support and an optically anisotropic layer made from liquid crystal molecules has been proposed in place of the stretched birefringent film. In preparation of the optical anisotropic layer of the optical compensatory sheet from the liquid crystal molecules, the liquid crystal molecules are aligned and oriented so uniformly that optical characteristics can be optimized.

A surface of the support is physically or chemically treated to align the liquid crystal molecules. The support surface is, for example, covered with a layer (or film) of polymer resin such as polyimide. The polymer layer (or film) is then subjected to a rubbing treatment. The layer is rubbed several times with cloth in a predetermined direction to form an orientation layer. The orientation layer orients the liquid crystal molecules in homogeneous alignment. In the homogeneous alignment, the molecules are aligned parallel to each other, and homogeneously oriented in the predetermined direction.

The above-mentioned rubbing treatment has generally been conducted to form the orientation layer of the optical compensatory sheet. However, static electricity is generated or dust rises in the rubbing treatment. Therefore, the production yield is often lowered. Further, it is difficult to control the orientation quantitatively.

A photo-controlled orientation (photo-orientation) method has been proposed to solve the problems of the rubbing treatment. A photo-isomerization reaction has been used to control orientation according to a known photo-orientation method. A process according to the photo-orientation method comprises the steps of: covering a surface of a support with a layer of a photo-isomerizable compound (which can be in the form of a polymer) as the orientation layer; and then exposing the layer to linearly polarized light to control orientation. When the layer is exposed to the linearly polarized light, molecules of the isomerizable compound are induced to isomerize. In isomerization, the molecular structure or the alignment is changed to orient liquid crystal molecules in a direction determined by a polarizing axis of the linearly polarized light. In this way, the liquid crystal molecules can be easily controlled and oriented in homogeneous alignment (cf., Polym. Mater. Sci. Eng., 66(1992), 263).

Another process of the photo-orientation method has been proposed (cf., Jpn. J. Appl. Phys., 74(1992), 2071; and Nature, 381(1996), 212). In the process, linearly polarized light is applied to a layer (or film) of polymer having a side chain derived from cinnamic acid or coumarin to cause a dimerization reaction between the side chains.

It is important to align liquid crystal molecules at a particular angle (tilt angle) to a support in preparation of an optical compensatory sheet. Liquid crystal molecules can be aligned at a tile angle according to a known process of the photo-orientation method. In the process, linearly polarized light is obliquely applied to a layer (or film) of a polymer having a side chain derived from cinnamic acid or coumarin (cf., Nature, 381(1996), 212; and J. Photopolym. Sci. Technol., 8(1995), 257). The process is well known to give homogeneous alignment.

A mercury lamp or a xenon lamp has usually been used as a light source. A layer is exposed to linearly polarized light obliquely to form an orientation layer. The light emitted from the lamp is polarized through a polarizing plate or a polarization splitter. An optical system comprising the lamp and the polarizer is slanted to expose the layer to the light obliquely. If an area of the layer to be exposed to the light is small, a mechanism for slanting the system can be simple. However, a liquid crystal display has been getting larger and wider in these days. Accordingly, it has been desired to produce a large and wide optical compensatory sheet. Therefore, the optical system is getting larger and more complicated. Further, it is getting more difficult to expose the layer to the polarized light uniformly. The process of the photo-orientation method is getting more difficult to use in preparation of an optical compensatory sheet.

Another process of the photo-orientation method has been known. In the process, a laser beam is applied to a layer of polymer such as polyimide to form an orientation layer. When the layer is exposed to the laser beam, the layer is partly decomposed and vaporized to carve grooves on a surface consisting of the polymer. Liquid crystal molecules can be aligned and oriented along the formed grooves. In the process, an excimer laser is generally used (cf., J. Photopolym. Sci. Technol., 2(1995), 241). The excimer laser is essentially poor in oscillation efficiency. Further, the excimer laser is unstable in emission intensity. Therefore, the excimer laser is not a suitable light source to expose a layer to light uniformly at small cost.

U.S. Pat. No. 6,061,113 discloses an optical compensatory sheet comprising a transparent support, an orientation layer and an optically anisotropic layer in order. The optically anisotropic layer contains an aligned and fixed discotic liquid crystal compound. The orientation layer has a function of aligning the discotic liquid crystal compound. The function of the orientation layer is activated by irradiating the layer with light from a single direction.

### DISCLOSURE OF INVENTION

An object of the present invention is to provide a process suitable for preparation of a large and wide optical compensatory sheet at small cost according to a photo-orientation method.

The present invention provides a process for preparation of an optical compensatory sheet comprising the steps in order of: coating a support with a photosensitive compound; exposing the photosensitive compound to beams of linearly polarized light emitted from a semiconductor laser to form an orientation layer; coating the orientation layer with a liquid crystal composition containing polymerizable liquid crystal molecules; aligning the liquid crystal molecules to form an optically anisotropic layer; and then polymerizing the liquid crystal molecules to fix alignment.

The beams of linearly polarized rays can be emitted from two or more semiconductor lasers. The beams are arranged in a row to form a line beam. The photosensitive compound is scanned with the line beam to form the orientation layer.

A collimator lens can be placed between the semiconductor lasers and the photosensitive compound. The collimator lens converts rays emitted from the lasers into the line beam.

The photosensitive compound preferably causes photo-isomerization or photo-dimerization when it is exposed to light emitted from the semiconductor laser.

The semiconductor laser preferably is a GaN semiconductor laser.

The semiconductor laser preferably emits light in the wavelength range of 350 nm to 450 nm.

The light emitted from the semiconductor laser can be applied perpendicularly to the support.

The light emitted from the semiconductor laser can also be applied obliquely to the support.

The liquid crystal molecules can be polymerizable rod-shaped liquid crystal molecules.

The liquid crystal molecules can also be polymerizable discotic liquid crystal molecules.

The liquid crystal molecules preferably have at least two polymerizable groups.

The liquid crystal molecules can be heated to align the molecules.

The liquid crystal composition can further contain a photopolymerization initiator. The liquid crystal molecules are irradiated with light to polymerize the molecules.

The process of the invention is free from static electricity and dust caused in the rubbing treatment of the conventional process. Therefore, the process is improved in production yield. The orientation layer is formed according to a process of the photo-orientation method, which is a non-contact treatment. Therefore, a large and wide compensatory sheet having uniform quality can be prepared without causing scratches. Further, laser rays can be arrayed in a row. A large and wide area of a layer can be exposed to the arrayed laser rays. In this way, the optical compensatory sheet is wide and large enough to suit a large liquid crystal display.

The optical compensatory sheet prepared according to the present invention enlarges a viewing angle of a liquid crystal display. The present invention makes it possible to produce a large and wide liquid crystal display, which gives an image of high quality uniformly.

### BRIEF DESCRIPTION OF DRAWINGS

FIG. 1 is a plane view schematically illustrating an apparatus in which a layer on a support is perpendicularly exposed to polarized line beam.

FIG. 2 is a side elevation view schematically illustrating an apparatus, in which a layer on a support is perpendicularly exposed to polarized line beam.

FIG. 3 is a plane view schematically illustrating an apparatus in which a layer on a support is obliquely exposed to polarized line beam.

FIG. 4 is a side elevation view schematically illustrating an apparatus in which a layer on a support is obliquely exposed to polarized line beam.

### BEST MODE FOR CARRYING OUT THE INVENTION

In the present invention, an optical compensatory sheet is prepared according to a process comprising the steps in order of:

(1) Coating a support with a photosensitive compound;

(2) Exposing the photosensitive compound to beams of linearly polarized light emitted from a semiconductor laser to form an orientation layer;

(3) Coating the orientation layer with a liquid crystal composition containing polymerizable liquid crystal molecules;

(4) Aligning the liquid crystal molecules to form an optically anisotropic layer; and then

(5) Polymerizing the liquid crystal molecules to fix alignment.

### (Support)

A support is made of a material on which an orientation layer can be formed. The support is usually transparent rather than opaque. A transparent support preferably has a light-transmittance of 80% or more. Examples of transparent materials include silica glass, hard glass, quartz and various polymers (described below). A film or plate of the transparent material can be used as the support. The film or plate can be coated with metal oxide (e.g., silicon oxide, tin oxide, indium oxide, aluminum oxide, titanium oxide, chromium oxide, zinc oxide), silicon nitride or silicon carbide. An opaque support can be a metal plate or a glass or plastic film coated with metal or metal oxide.

Examples of the polymers include cellulose esters, polycarbonate, polysulfone, polyacrylate, polymethacrylate and a norbornene resin. The support can be subjected to surface treatment to enhance adhesion between the support and a layer provided thereon (e.g., an adhesive layer, an orientation layer, an optically anisotropic layer). Examples of the surface treatments include a corona discharge treatment, a glow discharge treatment, a flame treatment, an acid treatment, an alkali treatment and an ultraviolet (UV) treatment. An undercoating layer (or adhesive layer) can be formed on the support in place of or in addition to the surface treatment.

### (Orientation Layer)

An orientation layer is made from a photosensitive compound. The photosensitive compound can be in the form of a polymer. The orientation layer is preferably made from a photosensitive polymer.

The photosensitive compound preferably is a photochromic compound. When the photochromic compound is exposed to light, the compound changes its chemical structure to further changes its optical characteristics (e.g., hue, color) according to the light. The change is generally reversible.

Examples of the known photosensitive compounds include azobenzene (K. Ichimura et al., Langmuir, 4(1988), 1214; K. Aoki et al., Langmuir, 8(1992), 1007; Y. Suzuki et al., Langmuir, 8(1992), 2601; K. Ichimura et al., Appl. Phys. Lett., 63(1993), No. 4, 449; N. Ishizuki, Langmuir, 9(1993), 3298; N. Ishizuki, Langmuir, 9(1993), 857), azonaphthalene, azopyridine, hydrazono-β-ketoester (S. Yamamura et al, Liquid Crystals, 13(1993), No. 2, 189), stilbene (K. Ichimura et al., Papers on polymer, 47(1990), No. 10, 771 (written in Japanese)), stilbazole, stilbazolium, chalcone, cinnamic acid, cinnamykideneacetic acid and spiropyran compounds (K. Ichimura et al., Chemistry Letters, (1992), 1063; K. Ichimura et al., Thin Solid Films, 235(1993), 101).

A photosensitive compound preferably has a double bond of C═C, C═N or N═N. The compound comprises the following essential structures (1) and (2) and optional structures (3) to (5):

(1) A double bond of C═C, C═N or N═N;

(2) Cyclic structures positioned on both sides of the double bond (1) (not necessarily connecting directly to the bond (1));

(3) An optional linking group between the bond (1) and the cyclic structure (2);

(4) An optional substituent group of the carbon in the double bond (1); and

(5) An optional substituent group of the cyclic structure (2).

The double bond (1) preferably has a trans-form rather than a cis-form. Two or more double bonds can be present in one molecule of the compound. The two or more double bond structures are preferably conjugated. A cyclic structure can be sandwiched between two double bonds. This means that the compound can have such a molecular structure of (cyclic structure)-(double bond)-(cyclic structure)-(double bond)-(cyclic structure).

Examples of the cyclic structure (2) include benzene ring, naphthalene ring and a nitrogen-containing heterocyclic ring (e.g., pyridinium ring, benzopyridinium ring). The nitrogen-containing heterocyclic ring preferably comprises a carbon atom (not a nitrogen atom) that connects directly to the carbon or nitrogen atom of the double bond (1). The cyclic structure (2) most preferably is benzene ring.

Examples of the linking group (3) include —NH— and —CO—. The structure (2) preferably connects directly to the bond (1) without the linking group (3).

Examples of the substituent groups (4) include an aryl group (e.g., phenyl) and cyano. The carbon atom of the double bond (1) preferably does not have the substituent group (4). In other words, the carbon atom preferably connects to only the cyclic structure (2). Therefore, the double bond (1) is preferably —H═CH— or —CH═N—.

Examples of the substituent groups (5) include hydroxyl, carboxyl, sulfo, an alkoxy group (e.g., methoxy, hexyloxy), cyano, a halogen atom (e.g., fluorine atom, chlorine atom, bromine atom), an alkyl group (e.g., butyl, hexyl) and an alkylamino group (e.g., dimethylamino). Carboxyl and sulfo can be dissociated to release proton. Carboxyl and sulfo can also be in the form of a salt with a counter ion (e.g., an alkali metal ion). In the case that the cyclic structure (2) is benzene ring, the substituent group is preferably placed at para-position. In the case that molecules of the photosensitive compound are to be chemically combined with a polymer (as is described below), a functional group to react with the polymer is introduced as the substituent group (5) into each molecule.

A photosensitive compound is fixed to a surface of a support to form an orientation layer. The methods of fixing the photosensitive compound include: (a) coating a mixture of the photosensitive compound and a polymer on the support; (b) chemically binding the photosensitive compound to a polymer; (c) causing adsorption of the photosensitive compound on the surface of the support: and (d) chemically binding the photosensitive compound to the surface of the support.

If the support is a glass plate, the photosensitive compound can be adsorbed on or combined with the glass plate in the method (c) or (d). On the other hand, if the support is a polymer film, the method (a) or (b) is preferably adopted. A polymer film support is generally preferred to a glass plate support to reduce weight of a display device. Therefore, the methods (a) and (b) are preferred to the methods (c) and (d). The method (b) is more preferably used to fix the photosensitive compound tightly to the support.

The polymer used in the method (a) or (b) preferably is a hydrophilic polymer (e.g., gelatin, polyvinyl alcohol, polyacrylic acid, polymethacrylic acid). Polyvinyl alcohol, polyacrylic acid and polymethacrylic acid are particularly preferred.

The reaction between the photosensitive compound and the polymer in the method (b) is determined according to the polymer (particularly, nature of the functional group of the polymer). In the case that a polymer has hydroxyl group (such as polyvinyl alcohol), a photosensitive compound can be combined to the polymer by a reaction between an acid halide and hydroxyl group. In more detail, a halogenated acyl group (—COX, wherein X is halogen atom) is introduced into a photosensitive compound as a substituent group, and then the compound is combined to the polymer by the following reaction between the halogenated acyl group and hydroxyl group of the polymer.

Ph-COX+HO-Pl→Ph-CO—O-Pl+HX

in which Ph is a main part of the photosensitive compound, and Pl is a main chain of the polymer.

The photosensitive polymer is a photo-isomerizable polymer, a photo-dimerizable polymer or a photo-decomposable polymer. The polymer combined with the photosensitive compound (described above) is a typical (practically essential) photo-isomerizable polymer. Examples of the photo-dimerizable polymers include polyvinyl cinnamate. Examples of the photo-decomposable polymer include polyimide. The photo-decomposable polyimide is described in Japanese Patent Provisional Publication Nos. 5(1993)-34699, 6(1994)-289399 and 8(1996)-122792 and Manuscripts (written in Japanese) of 22nd forum on liquid crystal, page 1672A17, (1996).

The photosensitive orientation layer is preferably formed from a photo-isomerizable polymer (a polymer combined with a photosensitive compound) or from a photo-dimerizable polymer.

### (Formation of Orientation Layer)

A support is coated with a photosensitive compound (including a photosensitive polymer) to form a layer. The photosensitive compound is preferably dissolved or dispersed in an appropriate solvent to form a coating solution. The support can be coated with the solution to form the layer.

The support is coated according to a conventional coating method, such as a spin-coating method, a wire-bar coating method, an extrusion coating method, a direct gravure coating method, a reverse gravure coating method or a die-coating method. The coating solution is then dried to form a layer.

An orientation layer has a thickness preferably in the range of 0.01 to 2 μm, and more preferably in the range of 0.01 to 0.1 μm.

In the present invention, polarized light emitted from an inexpensive and stable semiconductor laser is applied to the layer. The layer undergoes the photo-isomerization reaction or the photo-dimerization reaction to have an orientation function. The formed orientation layer can orient liquid crystal molecules. The layer can be scanned with the laser light in the form of a spot beam or a line beam. The whole layer surface can be exposed to the laser light all at once. The laser light is preferably in the form of a line beam.

FIG. 1 is a plane view schematically illustrating an apparatus in which a layer on a support is perpendicularly exposed to polarized line beam. In FIG. 1, elements of the apparatus are schematically shown in the same plane.

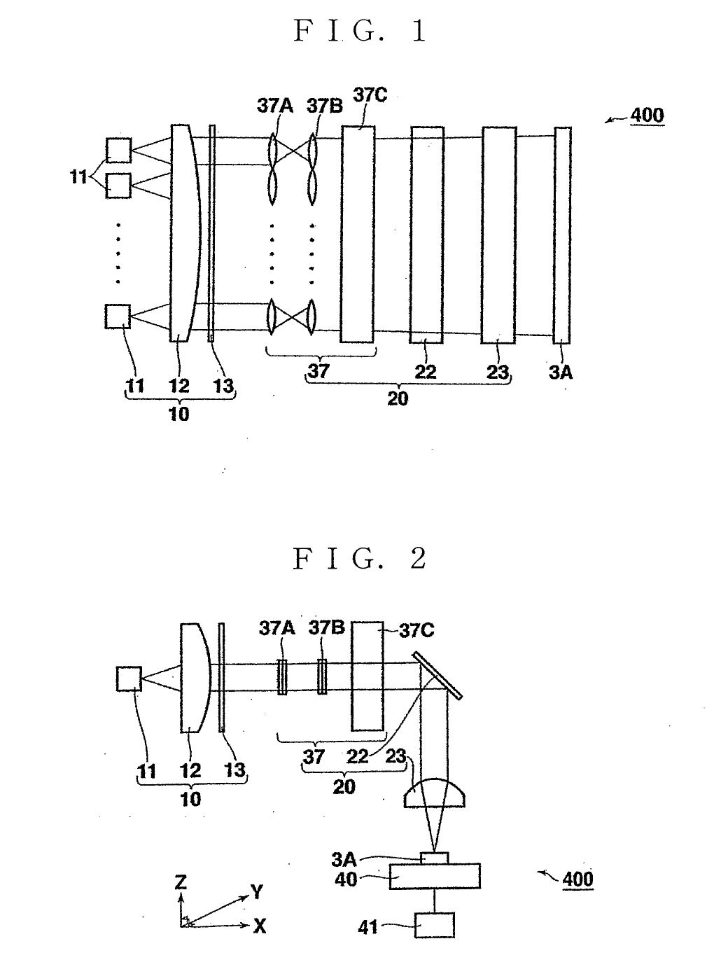

FIG. 2 is a side elevation view schematically illustrating an apparatus in which a layer on a support is perpendicularly exposed to polarized line beam.

In FIGS. 1 and 2, the apparatus 400 for forming an orientation layer comprises a linearly polarized light-emitting unit 10, an optical guide system 20 and a stage 40.

The light-emitting unit 10 in FIGS. 1 and 2 comprises two or more semiconductor lasers 11, a collimator lens 12 and a polarized light controller 13. Rays emitted from the plural lasers 11 pass through the collimator lens 12 placed between the semiconductor lasers 11 and a photosensitive compound, to be converted into parallel arrayed rays (line beam). The collimator lens 12 has a flat incident face and a convex takeoff face. The controller 13 converts the rays having passed through the collimator lens 12, into linearly polarized light L. The lasers 11 are connected to power supplies (not shown) by which the lasers are switched on or off.

The optical guide system 20 has a homogenizer unit 37, which comprises first lenses 37A, second lenses 37B and a cylindrical lens (e.g., rod lens) 37C. The first lenses 37A are linearly arrayed, and each of them individually corresponds to each semiconductor laser 11. Each first lens has convex incident and takeoff faces. Meanwhile, the second lenses 37B have the same constitution as the first lenses 37A, and are placed apart from the first lenses 37A. The distance between the first lenses 37A and the second lenses 37B is set to be almost twice as long as the focal length of the lenses. The cylindrical lens 37C further homogenizes the light having passed through the second lenses 37B.

In the optical guide system 20, a reflection mirror 22 and a condenser lens 23 are placed behind the homogenizer unit 37. The light is reflected by the mirror 22, and then condensed through the lens 23. The condenser lens 23 has a convex incident face and a flat takeoff face.

As shown in FIGS. 1 and 2, an organic layer 3A (spread coating liquid to be an orientation layer) can be almost perpendicularly exposed to linearly polarized light L (which is a line beam along the Y axis in FIG. 2) given off from the light-emitting unit 10 through the optical guide system 20. In the embodiment shown in FIGS. 1 and 2, since the layer 3A (a layer not yet able to orient liquid crystal) on the stage 40 is exposed to the line beam L along the Y axis, the stage 40 is moved uniaxially (along the X axis) by means of the stage controller 41. In this way, the whole organic layer 3A provided on the support can be exposed to the linearly polarized light L, so that the layer can work as the orientation layer (namely, so that the layer can orient liquid crystal).

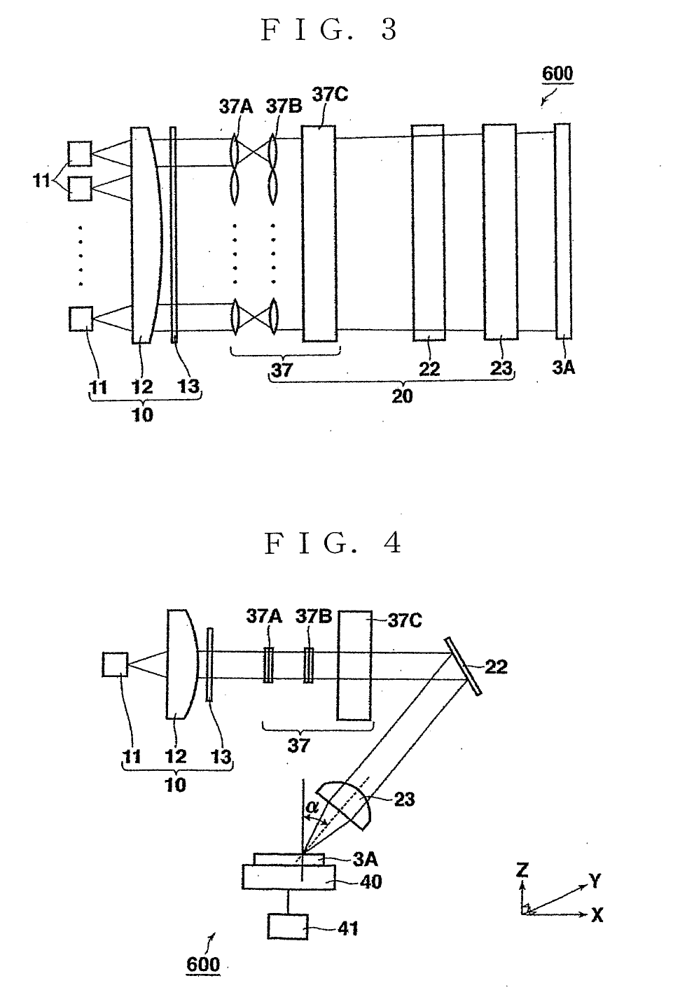

FIG. 3 is a plane view schematically illustrating an apparatus in which a layer on a support is obliquely exposed to polarized line beam. In FIG. 3, elements of the apparatus are schematically shown in the same plane.

FIG. 4 is a side elevation view schematically illustrating an apparatus in which a layer on a support is obliquely exposed to the polarized line beam.

The apparatus 600 in FIGS. 3 and 4 for treating the orientation layer also comprises a linearly polarized light-emitting unit 10, an optical guide system 20 and a stage 40.

The apparatus 600 in FIGS. 3 and 4 differs from the apparatus 400 in FIGS. 1 and 2, in that the mirror 22 of the optical system 20 in the apparatus 600 is controlled so that the organic layer 3A can be exposed to the polarized light L not perpendicularly but at the angle α° (α>0, preferably α>5) to the normal. Even in the case where the light L is thus obliquely exposed, the layer (orientation layer) 3A can be treated with the apparatus 600 in the same manner as with the apparatus 400 in FIGS. 1 and 2. In the orientation layer thus treated with the apparatus 600, molecules constituting the layer are oriented in an oblique direction, which is not the same as the direction of molecules in the layer treated by applying the light L perpendicularly (by means of the apparatus 400 in FIGS. 1 and 2).

### (Liquid Crystal Composition)

An optically anisotropic layer is prepared from a liquid crystal composition containing polymerizable liquid crystal molecules. The liquid crystal molecules include rod-shaped liquid crystal molecules or discotic liquid crystal molecules. The liquid crystal molecules are selected according to characteristics of an optical compensatory sheet. The composition can comprise a mixture of two or more kinds of polymerizable liquid crystal molecules. The composition can further contain liquid crystal molecules having no polymerizable groups.

Polymerizable rod-shaped liquid crystal molecules have already been known. The rod-shaped liquid crystal molecule preferably comprises two or three cyclic structures as the mesogen (rigid liquid crystal moiety). Examples of the mesogens include biphenyls, phenylcyclohexanes, phenylpyrimidines, phenyldioxanes, phenyl benzoates, phenyl cyclohexanecarboxylates, phenoxycarbonylphenyls, tolans, phenylcyclohexylphenyls, phenyldioxacyclohexylphenyl, phenoxymethylphenylmethylphenyls, bisphenyl terephthalates, bisphenyl cyclohexyldicarboxylates, (phenylcarbonyloxy)phenyl benzoates, phenyl phenylcarbonyloxybenzoates and bistolans.

The rod-shaped liquid crystal molecule has at least one polymerizable group, and preferably has at least two polymerizable groups. In consideration of durability of the produced compensatory sheet, the rod-shaped liquid crystal molecule preferably has two or more polymerizable groups. The polymerizable group preferably is an unsaturated polymerizable group, epoxy, aziridinyl, isocyanate or thioisocyanate, more preferably is an unsaturated polymerizable group, and most preferably is an ethylenically unsaturated group. The ethylenically unsaturated polymerizable group is preferably contained in an acryloyl and methacryloyl group.

The rod-shaped liquid crystal compound is preferably represented by the formula (I):

Q1-L1-A1-L3-M-L4-A2-L2-Q2 (I)

in which each of Q1 and Q2 independently is a polymerizable group; each of L1, L2, L3 and L4 independently is a single bond or a divalent linking group (at least one of L3 and L4 is preferably —O—CO—O—); each of A1 and A2 independently is a spacer group having 2 to 20 carbon atoms; and M is a mesogen group.

The rod-shaped liquid crystal compound of the formula (I) is further described below.

In the formula, each of Q1 and Q2 independently is a polymerizable group. The polymerizable group preferably undergoes addition polymerization (including ring-opening polymerization) or condensation polymerization. Examples of the polymerizable groups are shown below.

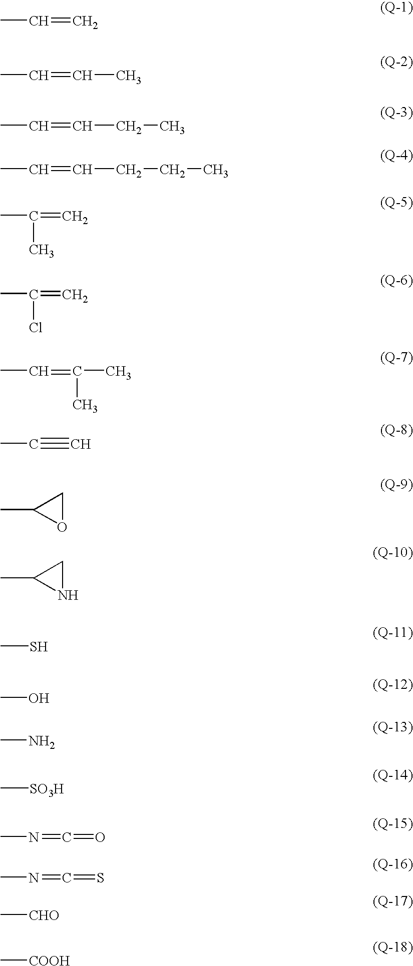

The divalent linking group represented by L1, L2, L3 or L4 preferably is —O—, —S—, —CO—, —NR2-, —CO—O—, —O—CO—O—, —CO—NR2-, —NR2-CO—, —O—CO—, —O—CO—NR2-, —NR2-CO—O— or NR2-CO—NR2- (in which R2 is hydrogen or an alkyl group having 1 to 7 carbon atoms). At least one of L3 and L4 preferably is —O—CO—O— (carbonate). Each of Q1-L1 and Q2-L2 in the formula (I) preferably is CH₂═CH—CO—O—, CH₂═C(CH₃)—CO—O— or CH₂═C(Cl)—CO—O—CO—O—, and more preferably is CH₂═CH—CO—O—.

In the formula (I), each of A1 and A2 represents a spacer group having 2 to 20 carbon atoms. The spacer group preferably is an aliphatic group having 2 to 12 carbon atoms, and more preferably is an alkylene group. The spacer group preferably has a chain structure. The spacer group can contain an oxygen atom or a nitrogen atom. The spacer group can have a substituent group such as a halogen atom (fluorine, chlorine, bromine), cyano, methyl or ethyl.

The mesogen group represented by M in the formula (I) has already been. The mesogen group is preferably represented by the formula (II):

-(-W1-L5)ₙ-W2- (II)

in which each of W1 and W2 is independently a divalent cyclic aliphatic group, a divalent aromatic group or a divalent heterocyclic group; L5 is a single bond or a linking group; and n is an integer of 1, 2 or 3. Examples of the linking group L5 include —CH₂—O—, —O—CH₂— and the examples of L1 to L4 in the formula (I).

Examples of W1 and W2 include 1,4-cyclohexanediyl, 1,4-phenylene, pyrimidine-2,5-diyl, pyridine-2,5-diyl, 1,3,4-thiadiazole-2,5-diyl, 1,3,4-oxadiazole-2,5-diyl, naphthalene-2,6-diyl, naphthalene-1,5-diyl, thiophene-2,5-diyl and pyridazine-3,6-diyl. The 1,4-cyclohexanediyl may be in trans-form, in cis-form or in mixture of them, but is preferably in trans-form. Each of W1 and W2 can have a substituent group. Examples of the substituent group include a halogen atom (fluorine, chlorine, bromine, iodine), cyano, an alkyl group having 1 to 10 carbon atoms (e.g., methyl, ethyl, propyl), an alkoxy group having 1 to 10 carbon atoms (e.g., methoxy, ethoxy), an acyl group having 1 to 10 carbon atoms (e.g., formyl, acetyl), an alkoxycarbonyl group having 1 to 10 carbon atoms (e.g., methoxycarbonyl, ethoxycarbonyl), an acyloxy group having 1 to 10 carbon atoms (e.g., acetyloxy, propionyloxy), notro, trifluoromethyl and difluoromethyl.

Preferred examples of the mesogen group represented by the formula (II) are shown below. Each following example can have the substituent group described above.

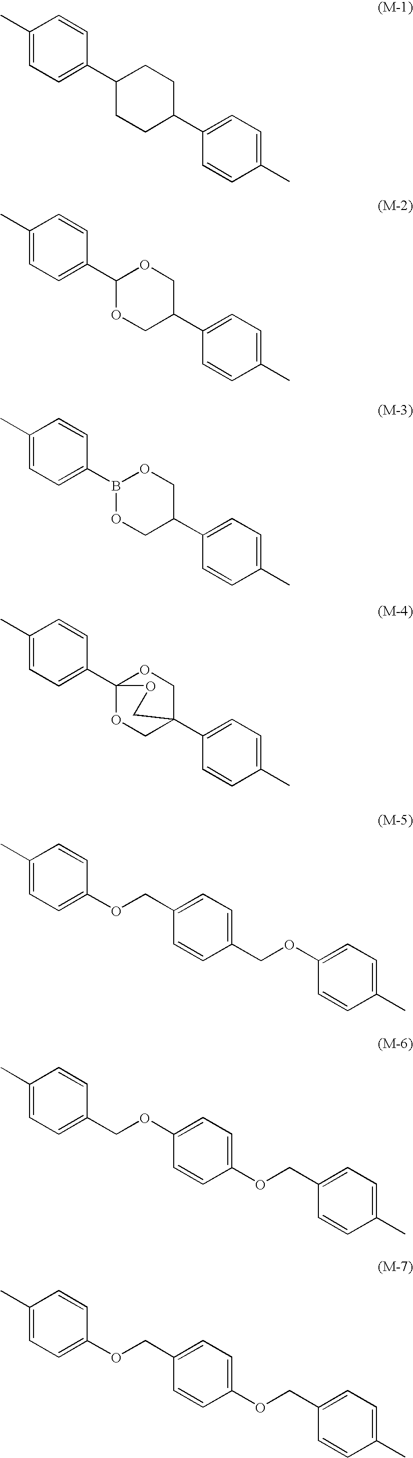

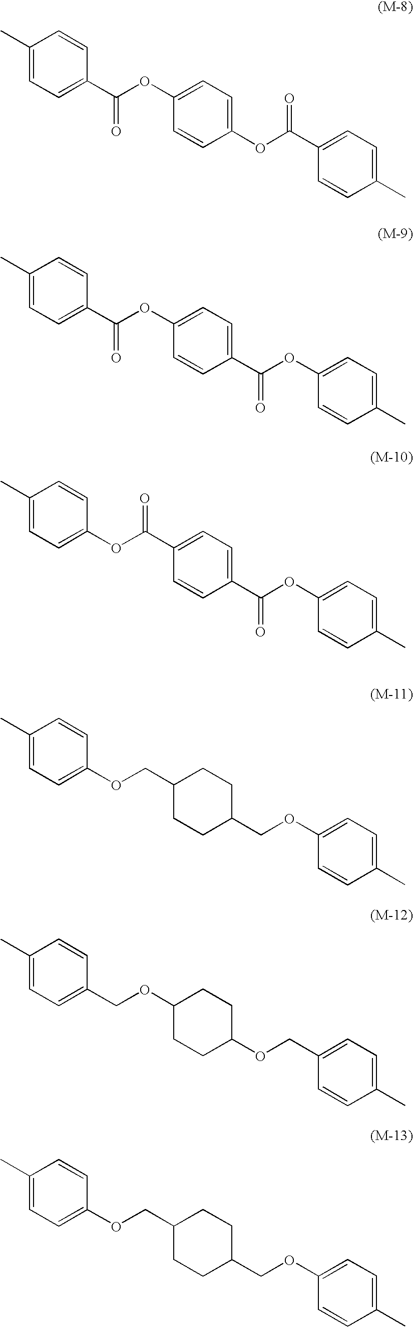

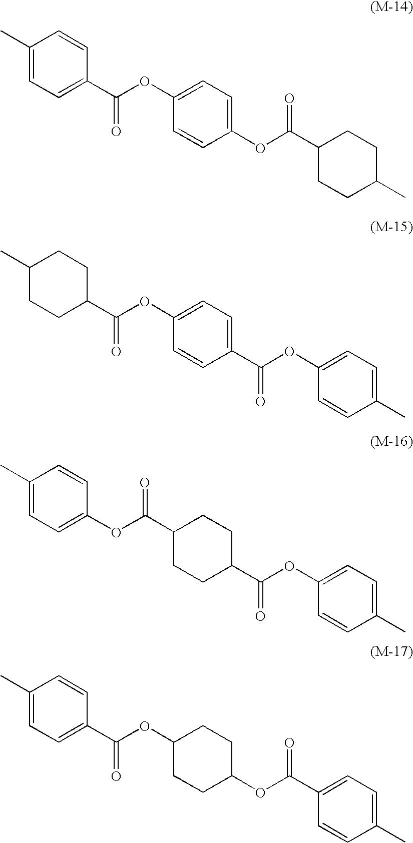

Examples of the compound represented by the formula (I) are shown below. The compound of the formula (I) can be synthesized according to the process described in Japanese Patent Provisional Publication No. 11(1999)-513019.

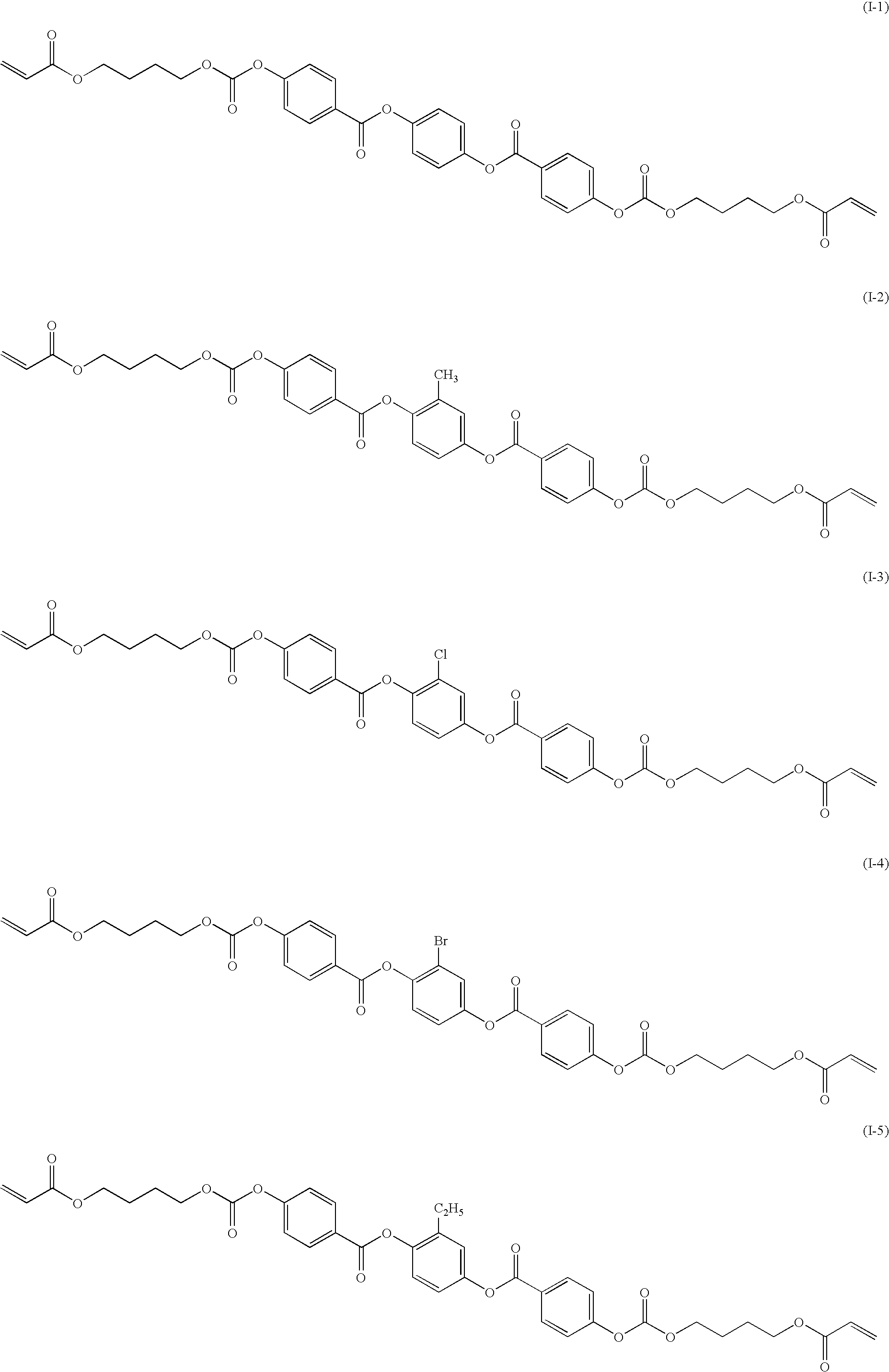

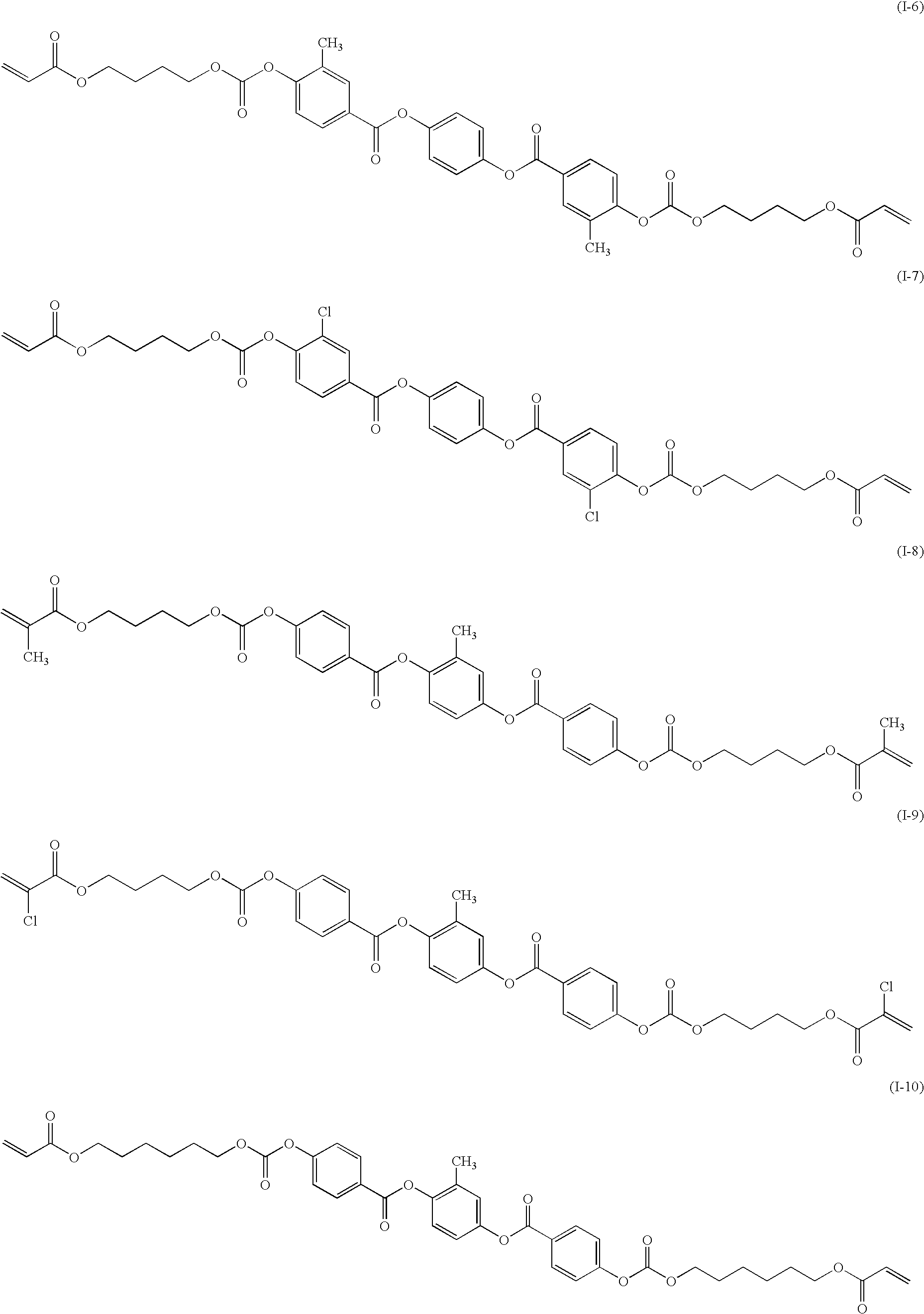

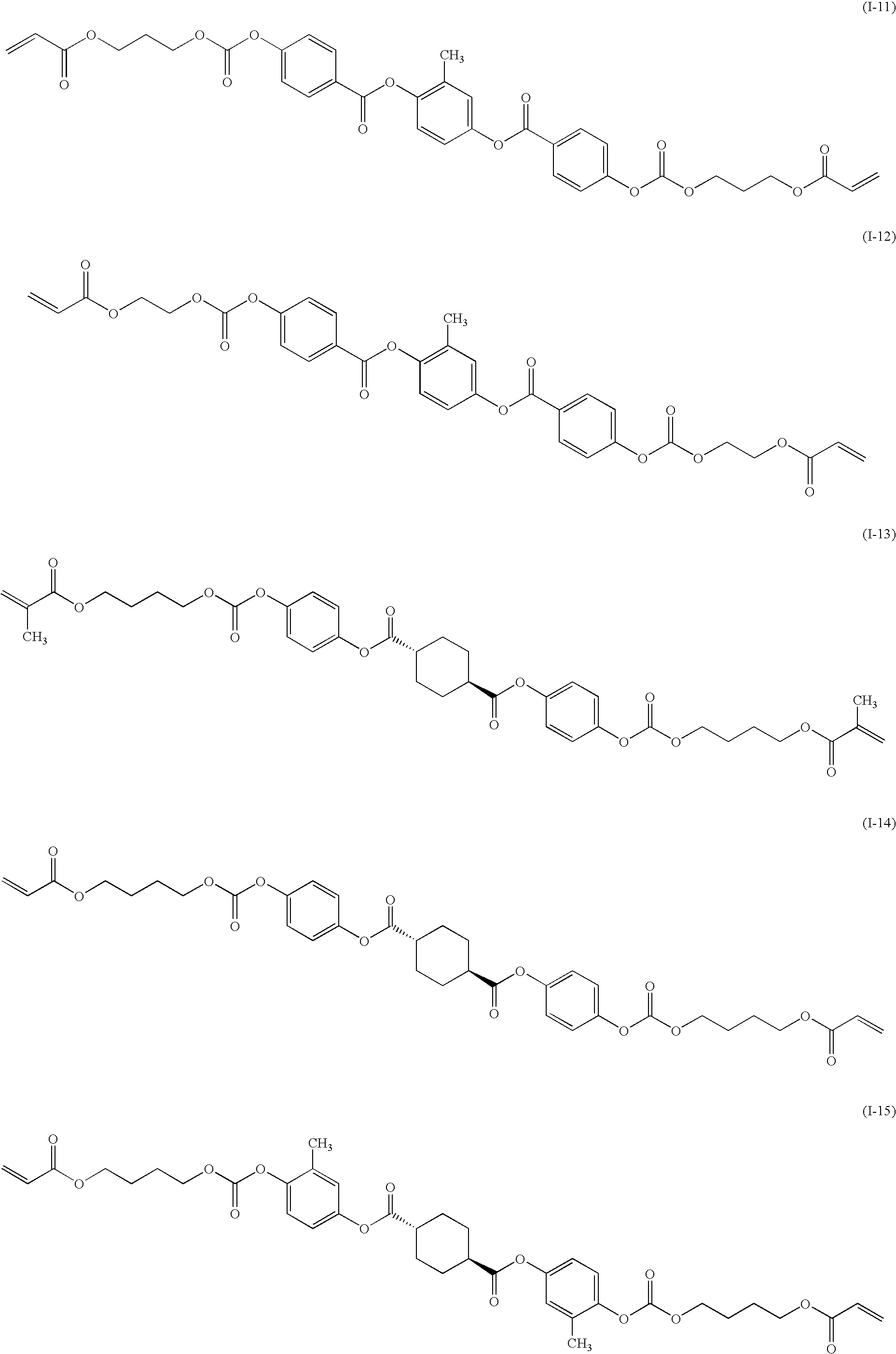

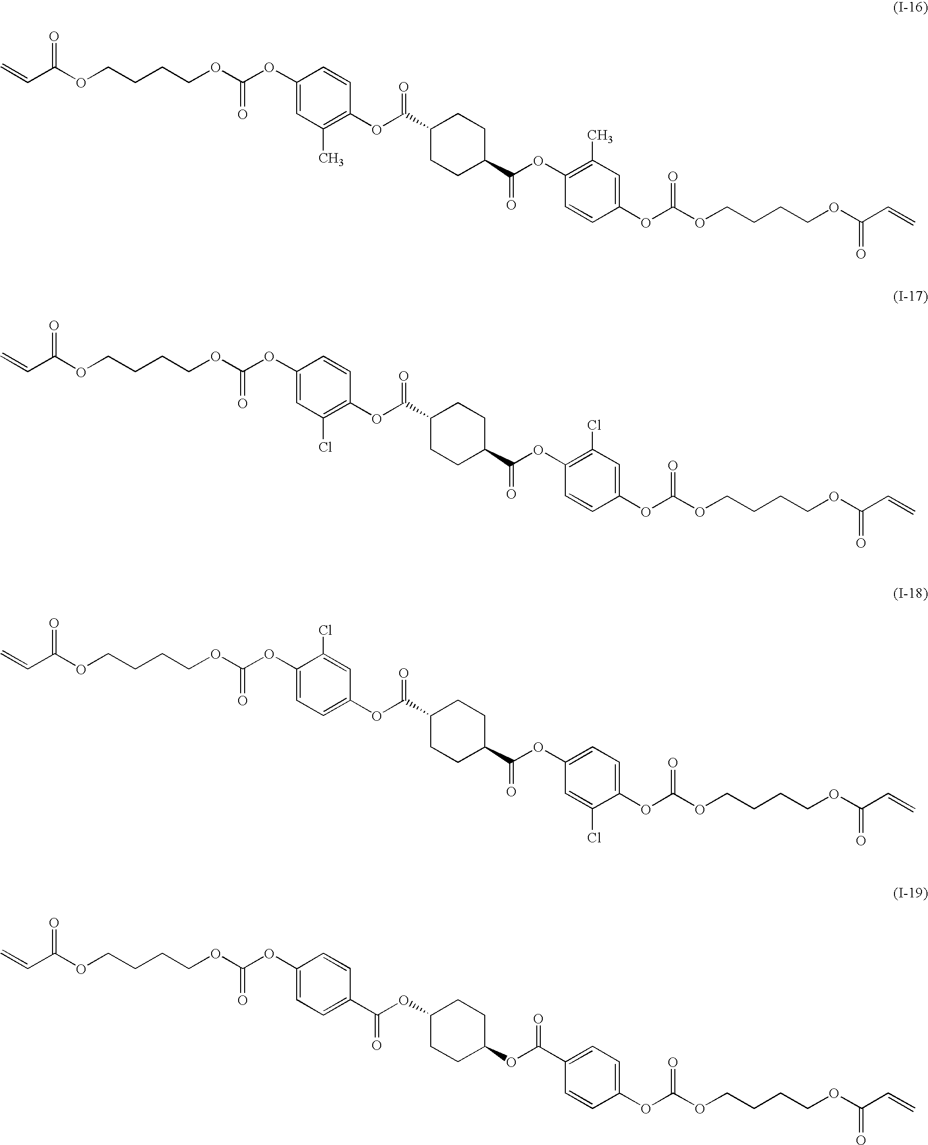

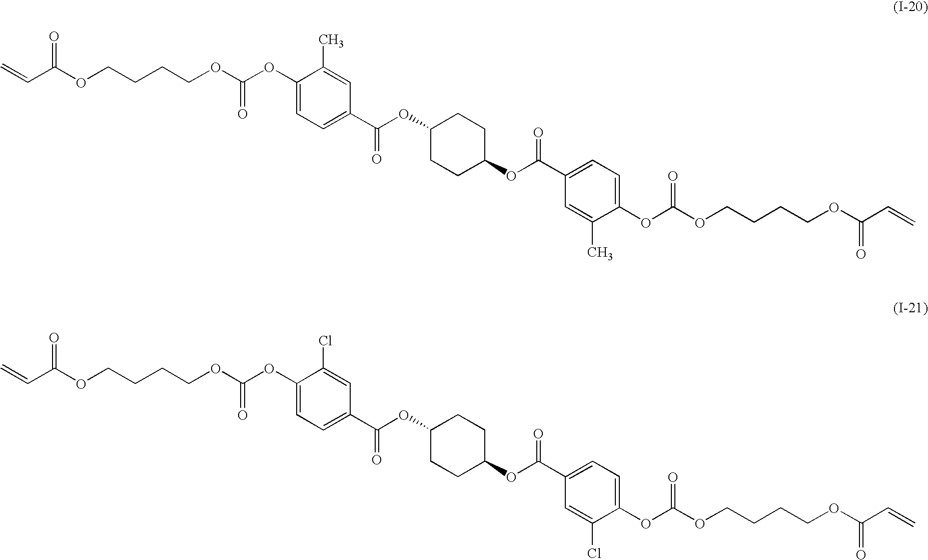

The liquid crystal compound preferably forms nematic liquid crystal phase or smectic A liquid crystal phase. Those phases appear preferably in the temperature range of room temperature to 200° C., more preferably in the temperature range of 50 to 130° C.

Known polymerizable discotic liquid crystal compounds are also usable. The discotic liquid crystal compound preferably forms discotic-nematic liquid crystal phase, and also preferably has a molecular structure containing triphenylene mother core. The discotic-nematic phase appears preferably in the temperature range of room temperature to 200° C., more preferably in the temperature range of 50 to 130° C.

Each discotic liquid crystal molecule used in the invention has at least one polymerizable group. In consideration of durability of the produced compensatory sheet, each molecule preferably has two or more polymerizable groups. The polymerizable group is preferably an unsaturated polymerizable group, epoxy, aziridinyl, isocyanate or thioisocyanate; more preferably an unsaturated polymerizable group, and most preferably an ethylenically unsaturated group. Examples of the polymerizable group include acryloyl and methacryloyl.

The discotic liquid crystal compound is preferably represented by the following formula (III):

D(-L-Q)ₙ (III)

in which D is a discotic core; L is a divalent linking group; Q is a polymerizable group; and n is an integer of 4 to 12.

Examples of the discotic cores (D) are shown below. In the examples, LQ (or QL) means the combination of the divalent linking group (L) and the polymerizable group (Q).

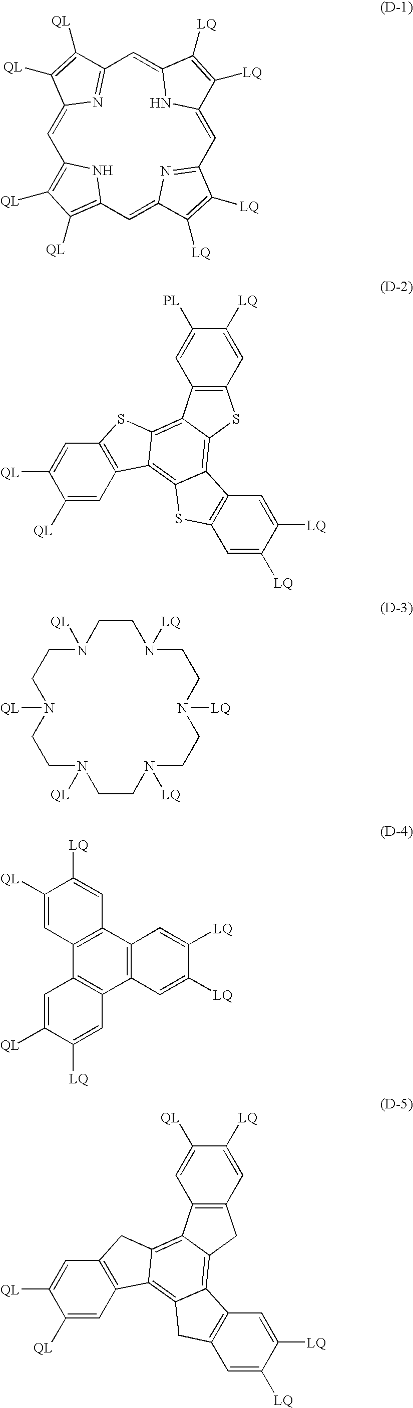

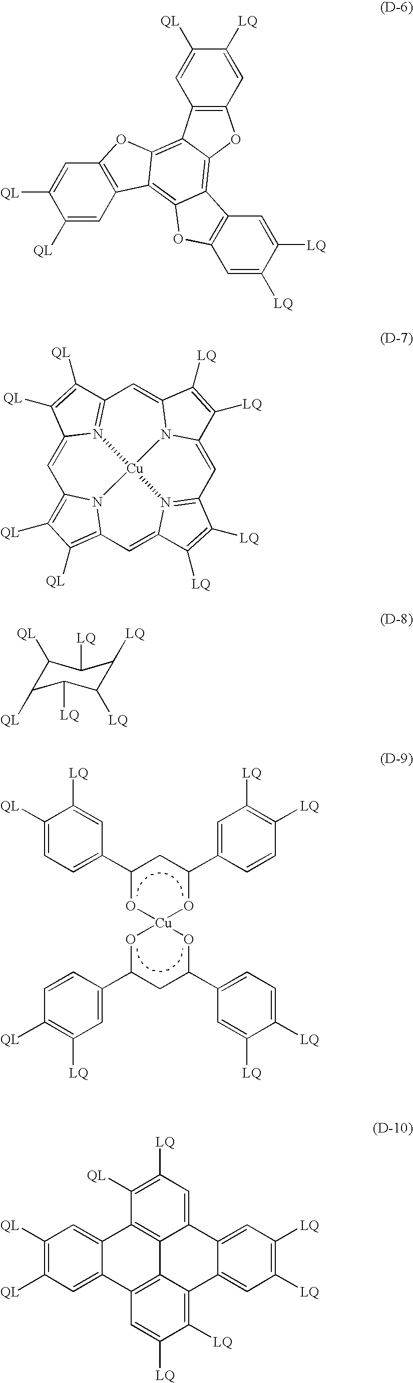

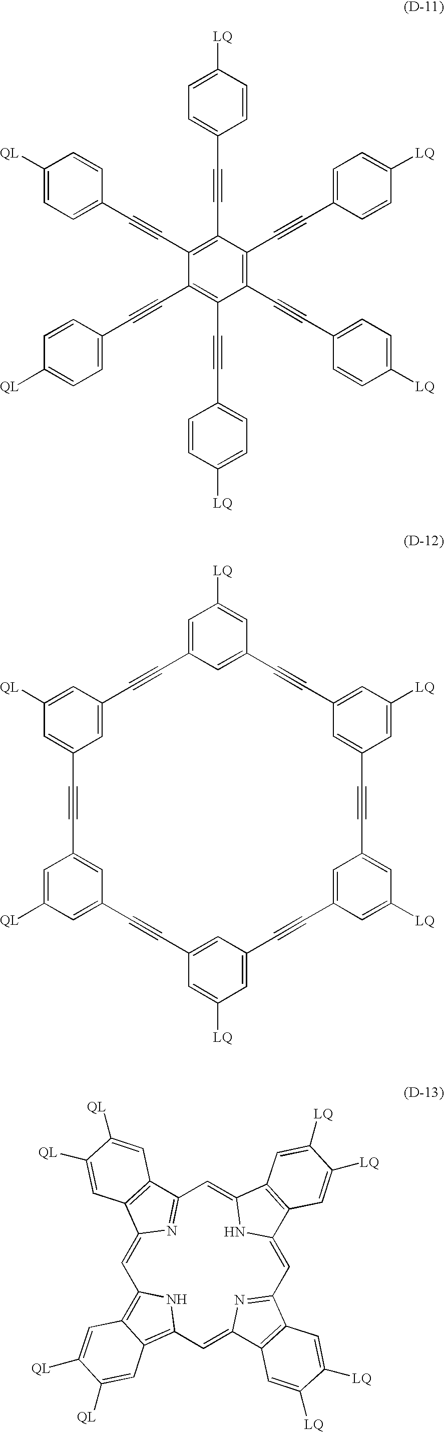

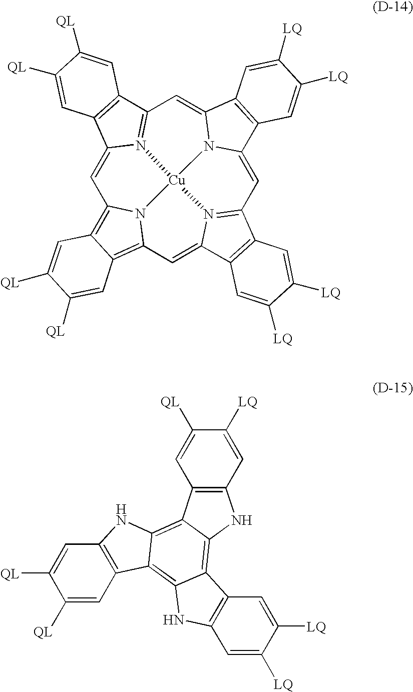

In the formula (III), the divalent linking group (L) preferably is selected from the group consisting of an alkylene group, an alkenylene group, an arylene group, —CO—, —NH—, —O—, —S— and combinations thereof. L more preferably is a divalent linking group comprising at least two divalent groups selected from the group consisting of an alkylene group, an alkenylene group, an arylene group, —CO—, —NH—, —O— and —S—. L further preferably is a divalent linking group comprising at least two divalent groups selected from the group consisting of an alkylene group, an alkenylene group, an arylene group, —CO— and —O—. The alkylene group preferably has 1 to 12 carbon atoms. The alkenylene group preferably has 2 to 12 carbon atoms. The arylene group preferably has 6 to 10 carbon atoms. The alkylene group, the alkenylene group and the arylene group can have a substituent group (such as an alkyl group, a halogen atom, cyano, an alkoxy group, an acyloxy group).

Examples of the divalent linking groups (L) are shown below. In the examples, the left side is attached to the discotic core (D), and the right side is attached to the polymerizable group (Q). The AL means an alkylene group or an alkenylene group. The AR means an arylene group.
(L-1) -AL-CO—O-AL-
(L-2) -AL-CO—O-AL-O—
(L-3) -AL-CO—O-AL-O-AL-
(L-4) -AL-CO—O-AL-O—CO—
(L-5) —CO-AR-O-AL-
(L-6) —CO-AR-O-AL-O—
(L-7) —CO-AR-O-AL-O—CO—
(L-8) —CO—NH-AL-
(L-9) —NH-AL-O—
(L-10) —NH-AL-O—CO—
(L-11) —O-AL-
(L-12) —O-AL-O—
(L-13) —O-AL-O—CO—
(L-14) —O-AL-O—CO—NH-AL-
(L-15) —O-AL-S-AL-
(L-16) —O—CO-AL-AR-O-AL-O—CO—
(L-17) —O—CO-AR-O-AL-CO—
(L-18) —O—CO-AR-O-AL-O—CO—
(L-19) —O—CO-AR-O-AL-O-AL-O—CO—
(L-20) —O—CO-AR-O-AL-O-AL-O-AL-O—CO—
(L-21) —S-AL-
(L-22) —S-AL-O—
(L-23) —S-AL-O—CO—
(L-24) —S-AL-S-AL-
(L-25) —S-AR-AL-

The polymerizable group (Q) is determined according to the polymerization reaction. Examples of the polymerizable groups (Q) are the same as the Examples (Q-1) to (Q-18) described about the polymerizable groups of the rod-shaped liquid crystal molecules.

In the formula (III), n is an integer of 4 to 12, which is determined by the chemical structure of the discotic core (D). The 4 to 12 combinations of L and Q can be different from each other. However, the combinations are preferably identical.

Two or more discotic liquid crystal molecules can be used in combination. For example, a molecule containing asymmetric carbon atom in the divalent linking group (L) can be used in combination with a molecule containing no asymmetric carbon atom.

### (Additives in Liquid Crystal Composition)

A liquid crystal composition can contain additives in addition to the polymerizable liquid crystal molecules. Examples of the additives include a horizontal orientation promoter, an agent for preventing airflow from coursing unevenness, an anti-repelling agent, a polymerization initiator, a plasticizer (for lowing the temperature at which the liquid crystal phase appears) and polymerizable monomers. The total amount of the additives is not restricted unless they prevent the composition from working as liquid crystal, but is preferably 30 wt. % or less, more preferably 15 wt. % or less, based on the total weight of the composition. Each additive is individually described blow in detail.

### (Horizontal Orientation Promoter)

A horizontal orientation promoter aligns rod-shaped liquid crystal molecules so that the major axis of each molecule may be parallel or almost parallel to the support, in the case where the anisotropic layer is prepared from the rod-shaped liquid crystal compound. On the other hand, if the anisotropic layer is prepared from the discotic liquid crystal compound, the promoter aligns discotic molecules so that the discotic plane (mesogen core) of each molecule may be parallel or almost parallel to the support. In the present specification, the “horizontal orientation” means an orientation in which molecules are aligned at an angle of less than 10° to the horizontal. The angle is preferably in the range of 0 to 5°, more preferably in the range of 0 to 3°. The promoter is, for example, a discotic compound having a triazine or triphenylene skeleton.

(Agent for Preventing Airflow from Coursing Unevenness)

For preventing airflow from causing unevenness in spreading the liquid crystal composition, a fluorine-containing polymer can be preferably used together with the liquid crystal compound. The fluorine-containing polymer is not particularly restricted unless it unfavorably affects the tilt angle or the orientation of the liquid crystal molecules. Examples of the fluorine-containing polymer are described in Japanese Patent Provisional Publication No. 2004-198511, Japanese Patent Application Nos. 2003-129354, 2003-394998 and 2004-12139. If the discotic liquid crystal compound and the fluorine-containing polymer are used in combination, an image of high quality without unevenness can be obtained. The fluorine-containing polymer also prevents the surface of orientation layer from repelling the composition, and therefore makes it easy to spread the composition. The amount of the fluorine-containing polymer is preferably in the range of 0.1 to 2 wt. %, more preferably in the range of 0.1 to 1 wt. %, further preferably in the range of 0.4 to 1 wt. %, based on the amount of the liquid crystal compound, so that the polymer may not affect the orientation unfavorably.

### (Anti-Repelling Agent)

For preventing the layer surface from repelling the composition, a polymer can be preferably used together with the liquid crystal compound. The polymer is not particularly restricted unless it unfavorably affects the tilt angle or the orientation of the liquid crystal molecules. Examples of the polymer usable as the anti-repelling agent are described in Japanese Patent Provisional Publication No. 8(1996)-95030. As the anti-repelling agent, cellulose esters are preferably used. Examples of the cellulose esters include cellulose acetate, cellulose acetate propionate, hydroxypropyl cellulose, and cellulose acetate butylate. The amount of the polymer as the anti-repelling agent is preferably in the range of 0.1 to 10 wt. %, more preferably in the range of 0.1 to 8 wt. %, further preferably in the range of 0.1 to 5 wt. %, based on the amount of the liquid crystal compound, so that the polymer may not affect the orientation unfavorably.

### (Polymerization Initiator)

The polymerization initiator is a thermal polymerization initiator or a photo polymerization initiator. A photo polymerization initiator is preferred.

Examples of the photo polymerization initiators include α-carbonyl compounds (described in U.S. Pat. Nos. 2,367,661, 2,367,670), acyloin ethers (described in U.S. Pat. No. 2,448,828), α-hydrocarbon substituted aromatic acyloin compounds (described in U.S. Pat. No. 2,722,512), polycyclic quinone compounds (described in U.S. Pat. Nos. 2,951,758, 3,046,127), combinations of triarylimidazole dimer and p-aminophenyl ketones (described in U.S. Pat. No. 3,549,367), acridine or phenazine compounds (described in Japanese Patent Provisional Publication No. 60(1985)-105667 and U.S. Pat. No. 4,239,850) and oxadiazole compounds (described in U.S. Pat. No. 4,212,970). The amount of the photo polymerization initiator is preferably in the range of 0.01 to 20 wt. %, and more preferably in the range of 0.5 to 5 wt. %, based on the solid content of the composition.

### (Polymerizable Monomers)

Polymerizable monomers can be used together with the liquid crystal compound. The polymerizable monomers usable in the invention are not particularly restricted as long as they are compatible with the liquid crystal compound and unless they unfavorably affect the tilt angle or the orientation of the liquid crystal molecules. As the polymerizable monomers, compounds having active ethylenically unsaturated groups (such as vinyl, vinyloxy, acryloyl, and methacryloyl) are preferably used. The amount of the monomers is normally in the range of 1 to 50 wt. %, preferably in the range of 5 to 30 wt. %, based on the amount of the liquid crystal compound. A monomer having two or more reactive functional groups is particularly preferred since expected to enhance the adhesion between the orientation layer and the anisotropic layer.

### (Solvent)

The liquid crystal composition can be prepared as a coating solution. In preparing the coating solution, an organic solvent is preferably used. Examples of the solvent include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g., acetone, methyl ethyl ketone) and ethers (e.g., tetrahydrofuran, 1,2-dimethoxyethane). Alkyl halides and ketones are preferred. Two or more organic solvents can be used in combination.

### (Coating Process)

The coating solution can be spread to coat the orientation layer according to a conventional coating method (such as a spin coating method, a wire-bar coating method, an extrusion coating method, a direct gravure coating method, a reverse gravure coating method or a die coating method). The solution contains the liquid crystal compound preferably in the range of 1 to 50 wt. %, more preferably in the range of 10 to 50 wt. %, further preferably in the range of 20 to 40 wt. %.

### (Polymerization of Liquid Crystal Composition)

While the temperature is kept so that the liquid crystal composition can behave as liquid crystal, the polymerizable component in the liquid crystal composition is polymerized to fix the orientation of liquid crystal and thereby to form a stable optically anisotropic layer. Various known polymerization reactions are usable, but the reaction is preferably a radical polymerization initiated with a photo polymerization initiator and conducted with ultraviolet rays. The exposure energy is preferably in the range of 20 mJ/cm² to 50 J/cm², more preferably in the range of 100 to 800 mJ/cm². The polymerization can be conducted while the composition is heated to accelerate the photo polymerization reaction. The optically anisotropic layer has a thickness of preferably 0.1 to 20 μm, more preferably 0.5 to 15 μm, and most preferably 1 to 10 μm.

### (Use of Optical Compensatory Sheet)

The optical compensatory sheet produced according to the invention can be combined with a polarizing film, to prepare an elliptically polarizing plate. Further, if the optical compensatory sheet combined with the polarizing film is installed in a liquid crystal display of transmission type, the viewing angle of the display is enlarged. The elliptically polarizing plate and the liquid crystal display equipped with the optical compensatory sheet of the invention are described below.

### (Elliptically Polarizing Plate)

The optical compensatory sheet of the invention can be laminated on a polarizing film, to form an elliptically polarizing plate. The thus assembled elliptically polarizing plate can enlarge the viewing angle of liquid crystal display. Examples of the polarizing film include an iodine polarizing film, a polyene polarizing film and a dichromatic dye polarizing film. The iodine polarizing film and the dye polarizing film are generally prepared from stretched polyvinyl alcohol films. The polarizing film has a polarizing axis perpendicular to the stretching direction.

The polarizing film is placed on the anisotropic layer-side of the optical compensatory sheet. On the other side of the sheet, a transparent protective layer is preferably provided. The protective layer preferably has a light-transmittance of 80% or more. A cellulose ester film or a triacetylcellulose film is normally used as the protective layer. The cellulose ester film is preferably formed according to the solvent-cast method. The protective layer has a thickness of preferably 20 to 500 μm, more preferably 50 to 200 μm.

### EXAMPLES

In the following examples, Re(λ) and Rth(λ) are retardation values at the wavelength λ in the plane and along the thickness, respectively. The wavelength λ is generally set in the range of 450 to 750 nm. In the examples, the wavelength λ was set at 589 nm.

The value Re(λ) was measured by means of KOBRA-21ADH (OJI SCIENTIFIC INSTRUMENTS CO., LTD.) when incident light of λ nm came into the sheet in the normal direction. On the other hand, the value Rth(λ) was calculated with KOBRA-21ADH on the basis of the Re(λ), a retardation value measured when incident light of λ nm came into the sheet in the direction inclined at +40° to the normal around the slow axis (which was determined by KOBRA-21ADH) as the inclining axis (axis of rotation), and another retardation value measured when incident light of λ nm came into the sheet in the direction inclined at −40° to the normal around the slow axis as the inclining axis (axis of rotation). In calculating the values, average refractive indexes are generally assumed. The average refractive indexes can be assumed from, for example, Polymer Handbook (JOHN WILEY & SONS, INC.) and catalogues of various optical films. If unknown, the average refractive index can be measured with Abbe's refractmeter. Average refractive indexes of typical optical films are, by way of example, shown below:

| | |
|---|---|
| Cellulose acylate: | 1.48 |
| Cycloolefin polymer: | 1.52 |
| Polycarboante: | 1.59 |
| Polymethyl methacrylate: | 1.49 |
| Polystyrene: | 1.59 |

From the assumed average refractive index and the thickness, refractive indexes nx, ny and nz were calculated with KOBRA-21ADH.

### Example 1

As the coating liquid for forming the orientation layer, 1% dimethylformamide solution of Compound 1-1 (synthesized according to Japanese Patent provisional Publication No. 2004-83810) was prepared. The liquid was then spread to coat a glass support of 20 mm×25 mm according to the spin-coating method (at 5,000 rpm for 20 seconds), to form an orientation layer. Thus, a sample (the support on which the coating liquid was spread) was prepared. The sample was then placed on a stage so that the layer might be upside.

By means of the apparatus shown in FIG. 1, a line beam of laser light (wavelength: 406 nm) was exposed to the orientation layer. The stage was moved so that the exposure energy per unit area might be evenly 5 J/cm².

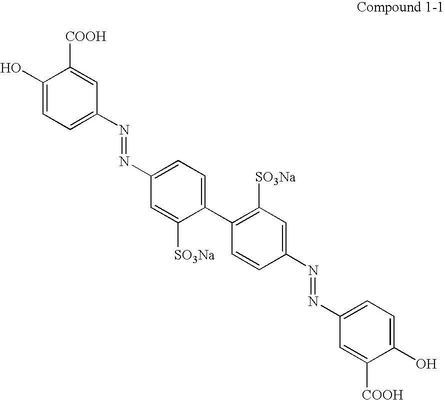

The following coating solution for forming the optically anisotropic layer was spread to coat the orientation layer by means of a wire bar coater, heated so that the spread solution might be at 100° C., and then cooled to 75° C. for approx. 20 seconds. While the temperature was kept, the spread solution was exposed to UV light in the amount of 0.4 J/cm² to fix the orientation. The thickness of the thus formed anisotropic layer was 1.3 μm. In this way, the optically anisotropic layer was formed to produce an optical compensatory sheet.

Coating solution for optically anisotropic layer

| | |
|---|---|
| The rod-shaped liquid crystal compound (I-2) | 100 weight parts |
| Photopolymerization initiator | 3.3 weight parts |
| (Irgacure 907, Ciba Speciality Chemicals) | |
| Sensitizer | 1.1 weight part |
| (Kayacure DETX, Nippon Kayaku Co., Ltd.) | |
| The following horizontal orientation promoter (3-1) | 0.3 weight part |
| Methyl ethyl ketone | 300 weight parts |

Rod-shaped liquid crystal compound (I-2)

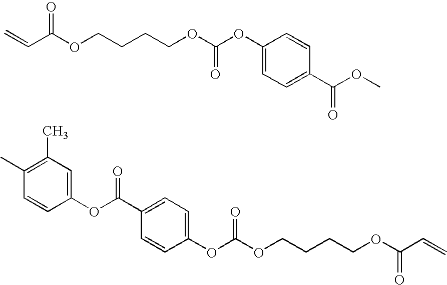

Horizontal orientation promoter (3-1)

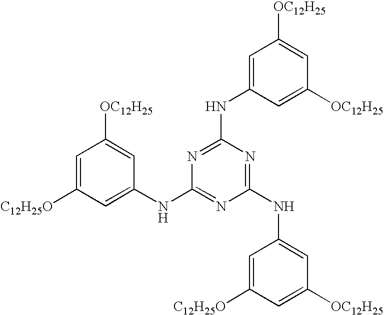

The rod-shaped liquid crystal compound (I-2) was synthesized according to PCT No. 97/00600 pamphlet. The horizontal orientation promoter (3-1) was synthesized according to Japanese Patent Provisional Publication No. 2003-344655.

The obtained sheet was observed through a polarizing microscope, to confirm that the liquid crystal was uniaxially oriented. The Re(589 nm) of the produced compensatory sheet was measured by means of KOBRA-21ADH (OJI SCIENTIFIC INSTRUMENTS CO., LTD.), to find 112 nm.

### Example 2

The 1% dimethylformamide solution of Compound 1-1 used in Example 1 was spread to coat a glass support of 100 mm×100 mm according to the spin-coating method (at 5,000 rpm for 20 seconds), to form an orientation layer. The thus-prepared sample was then placed on a stage so that the layer might be upside. By means of the apparatus shown in FIG. 3, a line beam of laser light (wavelength: 406 nm) was exposed to the orientation layer so obliquely that the incident angle of the beam might be 45°. The stage was moved so that the exposure energy per unit area might be evenly 5 J/cm².

The following coating solution for forming the optically anisotropic layer was then spread to coat the orientation layer by means of a wire bar coater, heated so that the spread solution might be at 120° C., and then cooled to 80° C. for approx. 20 seconds. While the temperature was kept, the layer was exposed to UV light in the amount of 0.4 J/cm² to fix the orientation. The thickness of the thus formed anisotropic layer was 1.9 μm. In this way, the optically anisotropic layer was formed to produce an optical compensatory sheet.

Coating solution for optically anisotropic layer

| | |
|---|---|
| The discotic liquid crystal compound (2-2) | 100 weight parts |
| Ethylene oxide denatured trimethlolpropanetriacrylate | 9.9 weight parts |
| (V#360, Osaka Organic Chemicals Co., Ltd.) | |
| Photopolymerization initiator (Irgacure 907, Ciba | 3.3 weight parts |
| Speciality Chemicals) | |
| Sensitizer | 1.1 weight part |
| (Kayacure DETX, Nippon Kayaku Co., Ltd.) | |
| Methyl ethyl ketone | 300 weight parts |

Discotic liquid crystal compound (2-2)

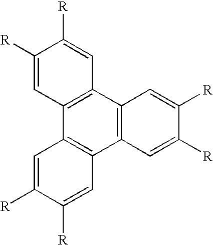

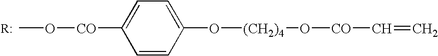

The discotic liquid crystal compound (2-2) was synthesized according to Polym. Adv. Technol., 11(2000), 398.

The Re(589 nm) and Rth(589 nm) of the produced sheet were measured by means of KOBRA-21ADH (OJI SCIENTIFIC INSTRUMENTS CO., LTD.), to find 127.5 nm and 191.9 nm, respectively.

### Example 3

The procedure of Example 1 was repeated except that 1% cyclohexanone solution of Compound 1-2 (as the coating liquid for forming the orientation layer) was spread to coat a triacetylcellulose support of 100 mm×100 mm by means of a wire bar coater, to form an orientation layer. Thus, an optical compensatory sheet was produced.

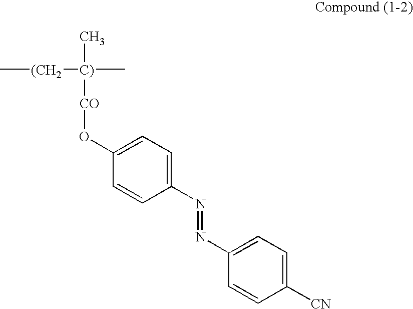

For preparing Compound (1-2), 4-cyano-4′-methacryloyloxyazobenzene was polymerized in the presence of azobisisobutyronitrile (polymerization initiator).

The produced compensatory sheet was observed through a polarizing microscope, to confirm that the liquid crystal was uniaxially oriented. The Re(589 nm) of the sheet was measured by means of KOBRA-21ADH (OJI SCIENTIFIC INSTRUMENTS CO., LTD.), to find 128 nm.

### Example 4

The procedure of Example 2 was repeated except that 1% cyclohexanone solution of Compound 1-2 (as the coating liquid for forming the orientation layer) was spread to coat a triacetylcellulose support of 100 mm×100 mm by means of a wire bar coater to form an orientation layer. Thus, an optical compensatory sheet was produced. The Re(589 nm) and Rth(589 nm) of the produced sheet were measured by means of KOBRA-21ADH (OJI SCIENTIFIC INSTRUMENTS CO., LTD.), to find 123.4 nm and 189.3 nm, respectively.

### INDUSTRIAL APPLICABILITY

The photo-orientation process adopted in the invention can be used for treating liquid crystal cells of various display modes. Examples of the display modes include TN (twisted nematic) mode, IPS (in-plane switching) mode, FLC (ferroelectric liquid crystal) mode, OCB (optically compensatory bend) mode, STN (super twisted nematic) mode, VA (vertically aligned) mode and HAN (hybrid aligned nematic) mode. Further, the photo-orientation process of the invention is also usable not only for producing optical elements (such as a phase retarder, an optical compensatory sheet and an optical switch) but also for treating various recording media (for recording information and for security system). In addition, optical compensatory sheets produced according to the invention can be combined with liquid crystal cells of various modes described above, to assemble liquid crystal displays.

1. A process for preparation of an optical compensatory sheet comprising the steps in order of: coating a support with a photosensitive compound; exposing the photosensitive compound to beams of linearly polarized light emitted from a semiconductor laser to form an orientation layer; coating the orientation layer with a liquid crystal composition containing polymerizable liquid crystal molecules; aligning the liquid crystal molecules to form an optically anisotropic layer; and then polymerizing the liquid crystal molecules to fix alignment.

2. The process as defined in claim 1, wherein the beams of linearly polarized rays are emitted from two or more semiconductor lasers, the beams are arranged in a row to form a line beam, and the photosensitive compound is scanned with the line beam to form the orientation layer.

3. The process as defined in claim 2, wherein a collimator lens is placed between the semiconductor lasers and the photosensitive compound, said collimator lens converting rays emitted from the lasers into the line beam.

4. The process as defined in claim 1, wherein the photosensitive compound causes photo-isomerization or photo-dimerization when it is exposed to light emitted from the semiconductor laser.

5. The process as defined in claim 1, wherein the semiconductor laser is a GaN semiconductor laser.

6. The process as defined in claim 1, wherein the semiconductor laser emits light in the wavelength range of 350 nm to 450 nm.

7. The process as defined in claim 1, wherein the light emitted from the semiconductor laser is applied perpendicularly to the support.

8. The process as defined in claim 1, wherein the light emitted from the semiconductor laser is applied obliquely to the support.

9. The process as defined in claim 1, wherein the liquid crystal molecules are polymerizable rod-shaped liquid crystal molecules.

10. The process as defined in claim 1, wherein the liquid crystal molecules are polymerizable discotic liquid crystal molecules.

11. The process as defined in claim 1, wherein the liquid crystal molecules have at least two polymerizable groups.

12. The process as defined in claim 1, wherein the liquid crystal molecules are heated to align the molecules.

13. The process as defined in claim 1, wherein the liquid crystal composition further contains a photopolymerization initiator, and the liquid crystal molecules are irradiated with light to polymerize the molecules.
